(19) United States
(12) Patent Application Publication
(10) Pub. No.: US 2013/0051363 A1
(43) Pub. Date: Feb. 28, 2013

(54) METHOD AND APPARATUS FOR AVOIDING BSR PROCEDURE WHEN NO LTE NETWORK IS AVAILABLE

(71) Applicants: ARVIND SWAMINATHAN, San Diego, CA (US); Srinivasan Balasubramanian, San Diego, CA (US)

(72) Inventors: ARVIND SWAMINATHAN, San Diego, CA (US); Srinivasan Balasubramanian, San Diego, CA (US)

(73) Assignee: QUALCOMM, Incorporated, San Diego, CA (US)

(21) Appl. No.: 13/572,398

(22) Filed: Aug. 10, 2012

Related U.S. Application Data
(60) Provisional application No. 61/528,706, filed on Aug. 29, 2011.

(51) Int. Cl. H04W 36/14; H04W 88/06

(52) U.S. Cl. 370/331

(57) ABSTRACT

Aspects disclosed herein relate to avoiding a better system reselection (BSR) procedure when no 3GPP (e.g., LTE based) network is available. In one example, a network entity may be equipped to determine that a geographic region (GEO) includes one or more cells that provide 3GPP coverage, and provision multi-mode system selection (MMSS) files to distinguish the GEO than includes one or more cells that support 3GPP coverage from one or more GEOs that do not include 3GPP coverage. Further, a user equipment (UE) may be equipped to detect initiation of a BSR procedure for a multimode UE currently being served by a 3GPP2 based network, and determine whether to scan for a 3GPP based network based on one or more MMSS files.

### CLAIM OF PRIORITY UNDER 35 U.S.C. §119

The present Application for Patent claims priority to Provisional Application No. 61/528,706 entitled “METHOD AND APPARATUS FOR AVOIDING BSR PROCEDURE WHEN NO LTE NETWORK IS AVAILABLE” filed Aug. 29, 2011, and assigned to the assignee hereof and hereby expressly incorporated by reference herein.

### BACKGROUND

1. Field

The present disclosure relates generally to communication systems, and more particularly, to systems and methods for wireless communication system selection.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with avoiding a better system reselection (BSR) procedure when no 3GPP (e.g., LTE based) network is available. In one example, a network entity may be equipped to determine that a geographic region (GEO) includes one or more cells that provide 3GPP coverage, and provision multi-mode system selection (MMSS) files to distinguish the GEO than includes one or more cells that support 3GPP coverage from one or more GEOs that do not include 3GPP coverage. Further, a user equipment (UE) may be equipped to detect initiation of a BSR procedure for a multimode UE currently being served by a 3GPP2 based network, and determine whether to scan for a 3GPP based network based on one or more MMSS files.

According to related aspects, a method for avoiding a better system reselection (BSR) procedure when no 3GPP network is available is provided. The method can include detecting initiation of a BSR procedure for a multimode UE currently being served by a 3GPP2 based network. Moreover, the method can include determining whether to scan for a 3GPP based network based on one or more MMSS files.

Another aspect relates to a communications apparatus. The wireless communications apparatus can include means for detecting initiation of a BSR procedure for a multimode UE currently being served by a 3GPP2 based network. Moreover, the communications apparatus can include means for determining whether to scan for a 3GPP based network based on one or more MMSS files.

Another aspect relates to a communications apparatus. The apparatus can include a processing system configured to detect initiation of a BSR procedure for a multimode UE currently being served by a 3GPP2 based network. Moreover, the processing system may be configured to determine whether to scan for a 3GPP based network based on one or more MMSS files.

Another aspect relates to a computer program product, which can have a computer-readable medium comprising code for detecting initiation of a BSR procedure for a multimode UE currently being served by a 3GPP2 based network. Moreover, the computer-readable medium can include code for determining whether to scan for a 3GPP based network based on one or more MMSS files.

According a related aspect, another method for avoiding a BSR procedure when no 3GPP network is available is provided. The method can include determining that a GEO includes one or more cells that provide 3GPP coverage. Moreover, the method can include provisioning MMSS files to distinguish the GEO than includes one or more cells that support 3GPP coverage from one or more GEOs that do not include 3GPP coverage.

Another aspect relates to a communications apparatus. The wireless communications apparatus can include means for determining that a GEO includes one or more cells that provide 3GPP coverage. Moreover, the communications apparatus can include means for provisioning MMSS files to distinguish the GEO than includes one or more cells that support 3GPP coverage from one or more GEOs that do not include 3GPP coverage.

Another aspect relates to a communications apparatus. The apparatus can include a processing system configured to determine that a GEO includes one or more cells that provide 3GPP coverage. Moreover, the processing system may be configured to provision MMSS files to distinguish the GEO than includes one or more cells that support 3GPP coverage from one or more GEOs that do not include 3GPP coverage.

Another aspect relates to a computer program product, which can have a computer-readable medium comprising code for determining that a GEO includes one or more cells that provide 3GPP coverage. Moreover, the computer-readable medium can include code for provisioning MMSS files to distinguish the GEO than includes one or more cells that support 3GPP coverage from one or more GEOs that do not include 3GPP coverage.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a hardware implementation for an apparatus employing a processing system;

FIG. 2 is a diagram illustrating an example of a network architecture;

FIG. 3 is a diagram illustrating an example of an access network;

FIG. 4 is a diagram describing Multi-Mode System Selection (MMSS) files provisioned according to an aspect;

FIG. 5 is another diagram describing MMSS files provisioned according to an aspect;

FIG. 6 is yet another diagram describing MMSS files provisioned according to an aspect;

FIG. 7 is a diagram illustrating a block diagram of an example UE for implementing one or more provisioned MMSS files, according to an aspect;

FIG. 8 is an example block diagram of a MMSS files provisioning system according to an aspect;

FIG. 9 is a flow chart of a method of wireless communication;

FIG. 10 is a flow chart of another method of wireless communication;

FIG. 11 is a conceptual block diagram illustrating the functionality of an exemplary apparatus; and

FIG. 12 is a conceptual block diagram illustrating the functionality of another exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

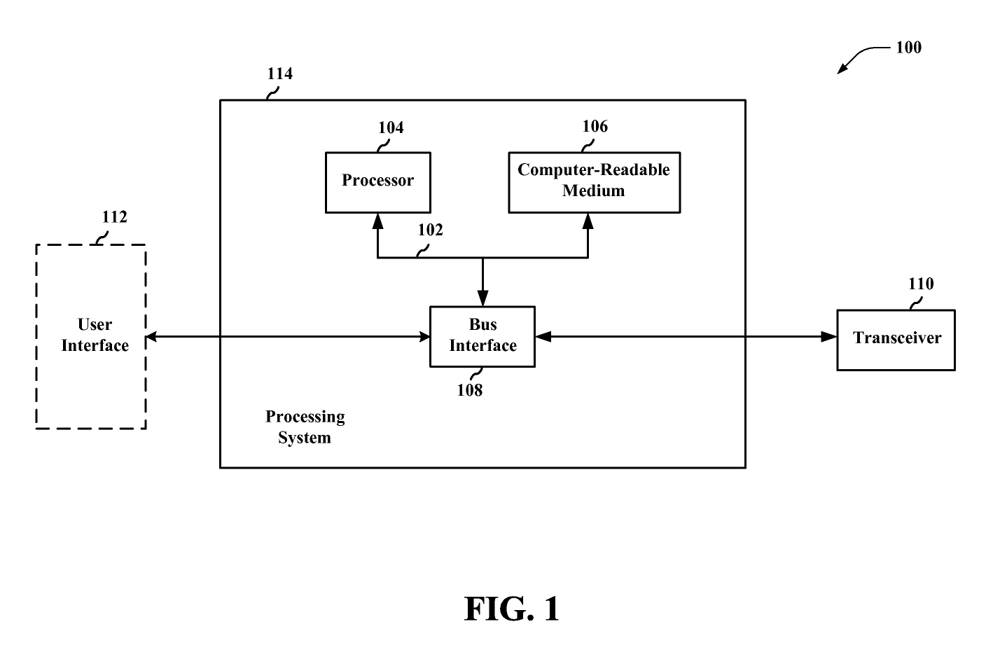

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

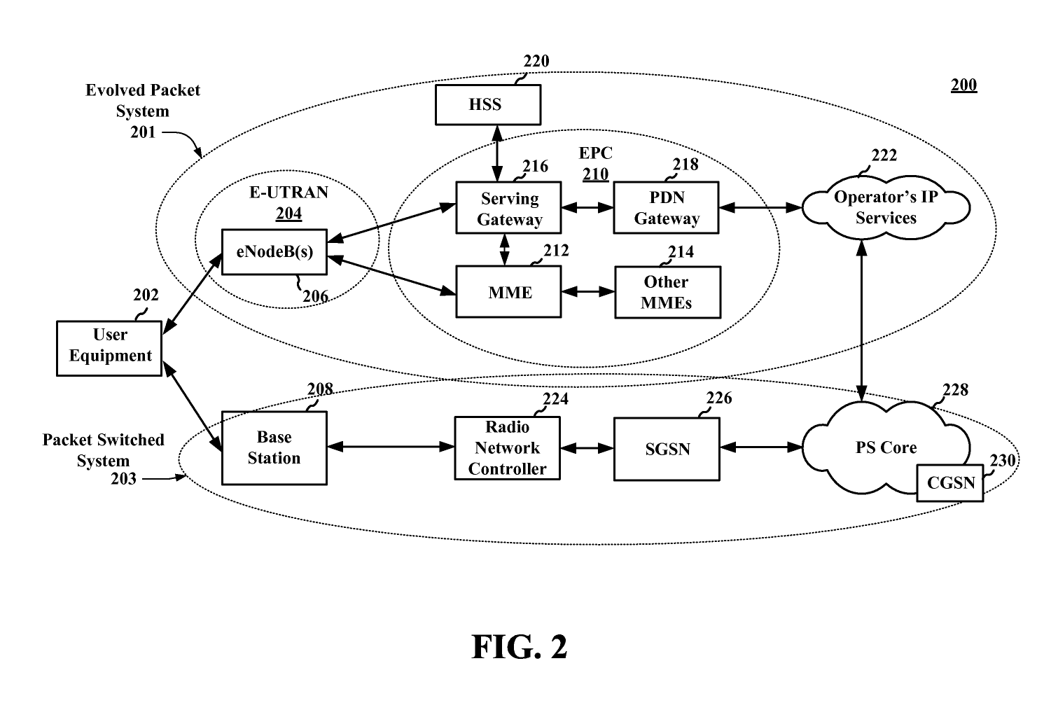

FIG. 2 is a diagram illustrating a wireless network architecture 200 employing various apparatuses. The network architecture 200 may include an Evolved Packet System (EPS) 201. One example of a system that implements EPS 201 is a Long Term Evolution (LTE) system. LTE is a set of enhancements to the Universal Mobile Telecommunications System (UMTS) mobile standard promulgated by Third Generation Partnership Project (3GPP). The network architecture 200 may include one or more user equipment (UE) 202, an Evolved UMTS Terrestrial Radio Access Network (E-UTRAN) 204, an Evolved Packet Core (EPC) 210, a Home Subscriber Server (HSS) 220, and an Operator's IP Services 222. The EPS can interconnect with other access networks, such as a packet switched core (PS core) 228, a circuit switched core (CS core) 234, etc. As shown, the EPS 201 provides packet-switched services, however, as those skilled in the art will readily appreciate, the various concepts presented throughout this disclosure may be extended to networks providing circuit-switched services, such as the network associated with CS core 234.

The network architecture 200 may further include a packet switched network 203. Network 203 may be implemented using any of the CDMA2000 family of standards. Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. In one aspect, the packet switched network 203 may include base station 208, base station controller 224, Serving GPRS Support Node (SGSN) 226, PS core 228 and Combined GPRS Service Node (CGSN) 230.

The E-UTRAN may include an evolved NodeB (eNB) 206 and connection to other networks, such as packet and circuit switched networks may be facilitated through a Mobility Management Entity (MME) 212. Further, through a connection between MME 212 and SGSN 226 a logical connection may be established between eNB 206 and RNC 224. The eNB 206 provides user and control plane protocol terminations toward the UE 202. The eNB 206 may be connected to the other eNBs 206 via an X2 interface (i.e., backhaul). The eNB 206 may also be referred to by those skilled in the art as a base station, a base transceiver station, a radio base station, a radio transceiver, a transceiver function, a basic service set (BSS), an extended service set (ESS), or some other suitable terminology. The eNB 206 provides an access point to the EPC 210 for a UE 202.

Examples of UE 202 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 202 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 206 is connected by an S1 interface to the EPC 210. The EPC 210 includes a MME 212, other MMEs 214, a Serving Gateway 216, and a Packet Data Network (PDN) Gateway 218. The MME 212 is the control node that processes the signaling between the UE 202 and the EPC 210. Generally, the MME 212 provides bearer and connection management. All user IP packets are transferred through the Serving Gateway 216, which itself is connected to the PDN Gateway 218. The PDN Gateway 218 provides UE IP address allocation as well as other functions. The PDN Gateway 218 is connected to the Operator's IP Services 222. The Operator's IP Services 222 may include the Internet, the Intranet, an IP Multimedia Subsystem (IMS), and a PS Streaming Service (PSS).

As Operators initially deploy LTE based networks, system 200 may include hotspots with LTE network 201 (e.g., 3GPP coverage) with broader coverage being provided through 2×/DO networks 203 (e.g., 3GPP2 coverage). A multimode UE 202 uses a BSR procedure to periodically scan available networks, determine whether a better network is available, and switch to the better network where one is available. Currently, BSR may be achieved through use of priority rules stored in Multi-mode System Selection Files (MMSS files) provisioned in a LTE+2×/DO multi-mode UE 202. Within the files, the systems can be grouped using mobile country code (MCC). As such, UE 202 may perform a BSR procedure even in areas with no LTE coverage, resulting in unnecessary power consumption.

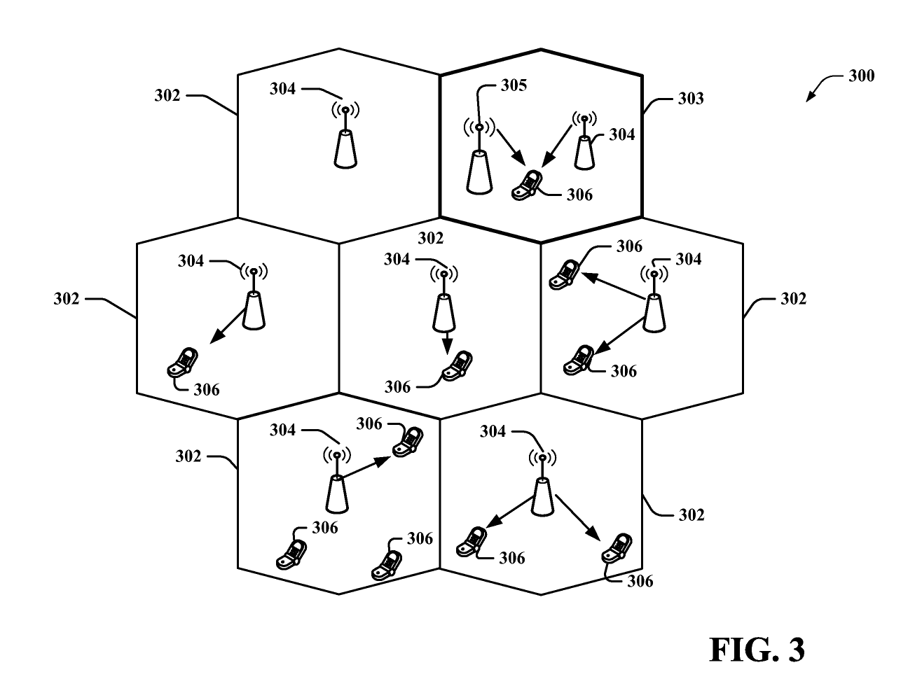

FIG. 3 is a diagram illustrating an example of an access network in a LTE network architecture. In this example, the access network 300 is divided into a number of geographic regions (GEOs) (302, 303). Each Geo may include one or more cellular regions (cells). One or more eNBs (304, 305) may be assigned to a GEO (302, 303) and each eNB may be configured to provide an access point to one or more systems (201, 203) for all the UEs 306 in the GEO (302, 303). There is no centralized controller in this example of an access network 300, but a centralized controller may be used in alternative configurations. The eNB (304, 305) is responsible for all radio related functions including radio bearer control, admission control, mobility control, scheduling, security, and connectivity to the serving gateway 216 and radio network controller 224 (see FIG. 2).

The modulation and multiple access scheme employed by the access network 300 may vary depending on the particular telecommunications standard being deployed. Each GEO may be provisioned to support one or more different cellular technologies. In LTE applications (e.g., 3rd Generation Partnership Project 3GPP), OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the (3GPP2 as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 304 may have multiple antennas supporting MIMO technology. The use of MIMO technology enables the eNB 304 to exploit the spatial domain to support spatial multiplexing, beamforming, and transmit diversity.

Spatial multiplexing may be used to transmit different streams of data simultaneously on the same frequency. The data steams may be transmitted to a single UE 306 to increase the data rate or to multiple UEs 306 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 306 with different spatial signatures, which enables each of the UE(s) 306 to recover the one or more data streams destined for that UE 306. On the uplink, each UE 306 transmits a spatially precoded data stream, which enables the eNB 304 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

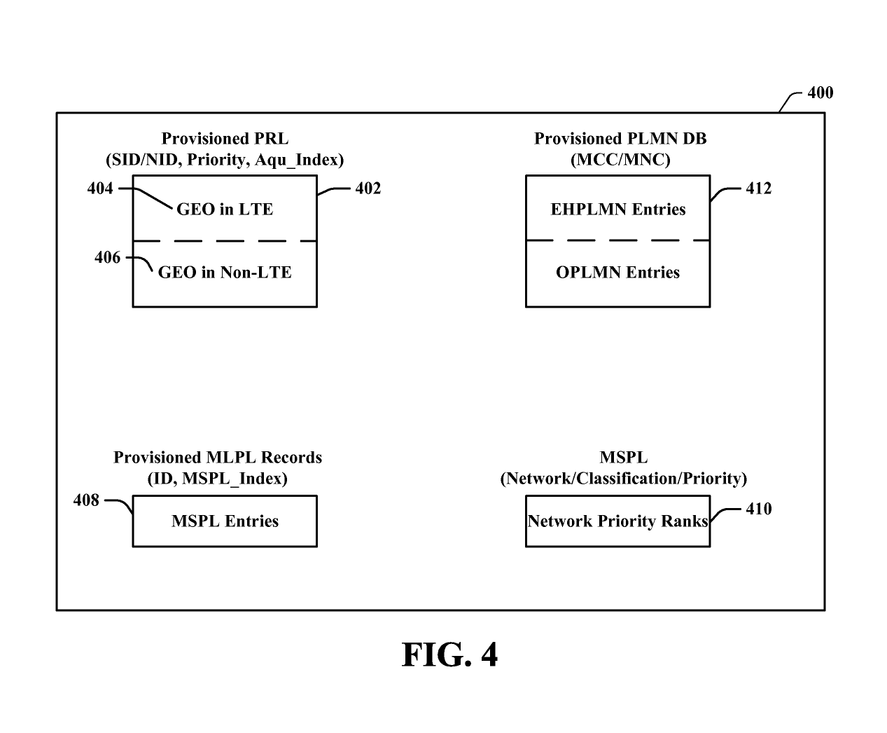

In one aspect, one or more GEOs 303 may include eNBs 305 that provide LTE coverage and eNBs 304 that provide 3GPP2 coverage. Other GEOs 302 may include eNBs 304 that provide 3GPP2 coverage yet do not include eNBs 305 that may provide LTE coverage. In GEOs 302 with no LTE coverage, UEs 306 need not perform a BSR procedure as there is no network available with a higher priority than the network through which they are currently be served. Therefore, multiple techniques are discussed in detail with respect to FIGS. 4-8 to reduce the number of BSR procedures that may be performed when UE 306 is in a GEO 302 that does not include LTE coverage.

FIG. 4 is a diagram illustrating an example of set MMSS files 400. Generally MMSS files 400 may include a preferred roaming list (PRL) 402, a MMSS location associated priority list (MLPL) 408, a MMSS system priority list (MSPL) 410, and a public land mobile network (PLMN) database 412. In one aspect, the PRL may be formatted to include at least a system identification number/network identification number (SID/NID), a priority value, and an acquisition index value. In one aspect, MLPL may include records formatted to at least include an identifier (e.g., mobile county code (MCC, SID/NID)), and a MSPL index value. In one aspect, MSPL may include records formatted to at least include a network descriptor, a classification value (e.g., home, any, etc.), and a priority value (e.g., More, Same, etc.). In one aspect, PLMN database may include MCC and mobile network values that may be included as an equivalent home PLMN (EHPLMN) entry, or an operator PLMN (OPLMN) entry.

One MMSS files provisioning scheme, as depicted in FIG. 4, uses the presence and/or absence of an extended system record in the PRL entry to distinguish between GEOs that include LTE coverage. In such an aspect, the extended system record included for GEOs that are within a LTE-Present Location 404 may be mapped using SID/NID to a standard MCC such as but not limited to, one of the United States MCCs (MCCs 310, 311, 312). By contrast, for GEOs that are within a LTE not present location 406 do not include extended system records. As such, no link to any MLPL is provided, and as such the BSR procedure may be terminated.

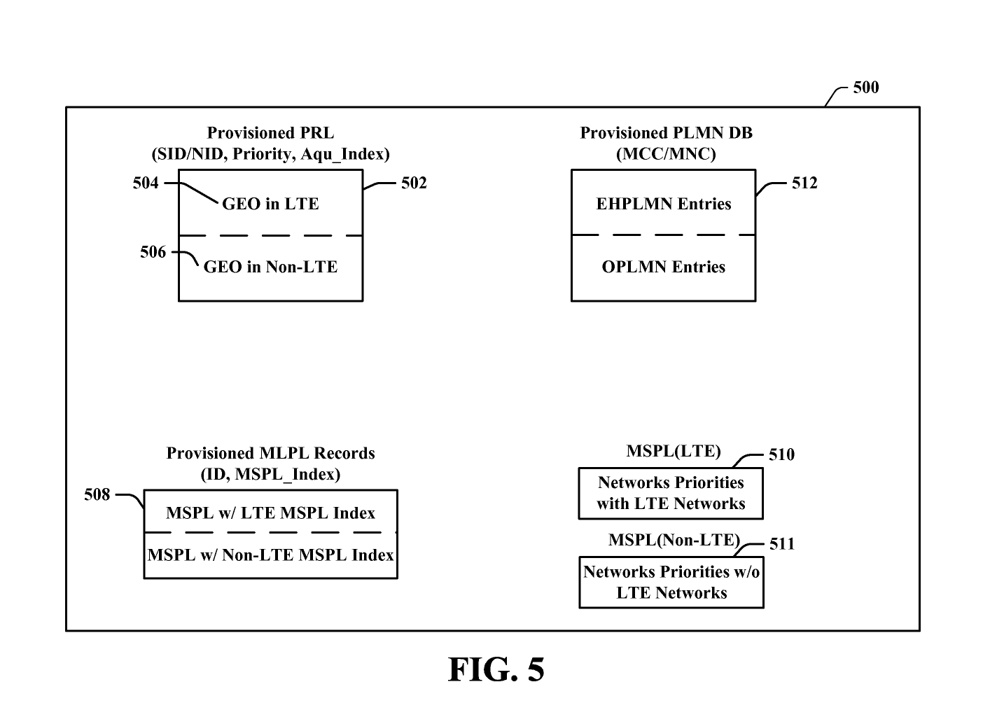

FIG. 5 is a diagram illustrating another example of set MMSS files 500. Generally MMSS files 500 may include a PRL 502, a MLPL 508, one or more MSPLs 510, 511, and a PLMN database 512. In one aspect, the PRL may be formatted to include at least a SID/NID, a priority value, and an acquisition index value. In one aspect, MLPL may include records formatted to at least include an identifier (e.g., mobile county code (MCC, SID/NID)), and a MSPL index value. In one aspect, MSPL may include records formatted to at least include a network descriptor, a classification value (e.g., home, any, etc.), and a priority value (e.g., More, Same, etc.). In one aspect, PLMN database may include MCC and mobile network values that may be included as an EHPLMN entry, or an OPLMN entry.

A MMSS files provisioning scheme, as depicted in FIG. 5, uses a pseudo MCC mapping scheme to differentiate between GEOs with and without LTE coverage. In such an aspect, the extended system record included for GEOs that are within a LTE-Present Location 504 may be mapped using SID/NID to a standard MCC such as but not limited to, one of the United States MCCs (MCCs 310, 311, 312). By contrast, for GEOs that are within a LTE not present location 506 to a reserved extended system record, such as but not limited to FFF. Further, the standard MCC values may be included in a MLPL record that links to a MSPL 510 which includes a 3GPP in its priority hierarchy. By contrast, the reserved MCC values may be included in a different MLPL record that links to a MSPL 511 that lists 3GPP2 as most preferred thereby avoid starting of a BSR timer when UE is camped one of the 3GPP2 systems that does not include LTE coverage.

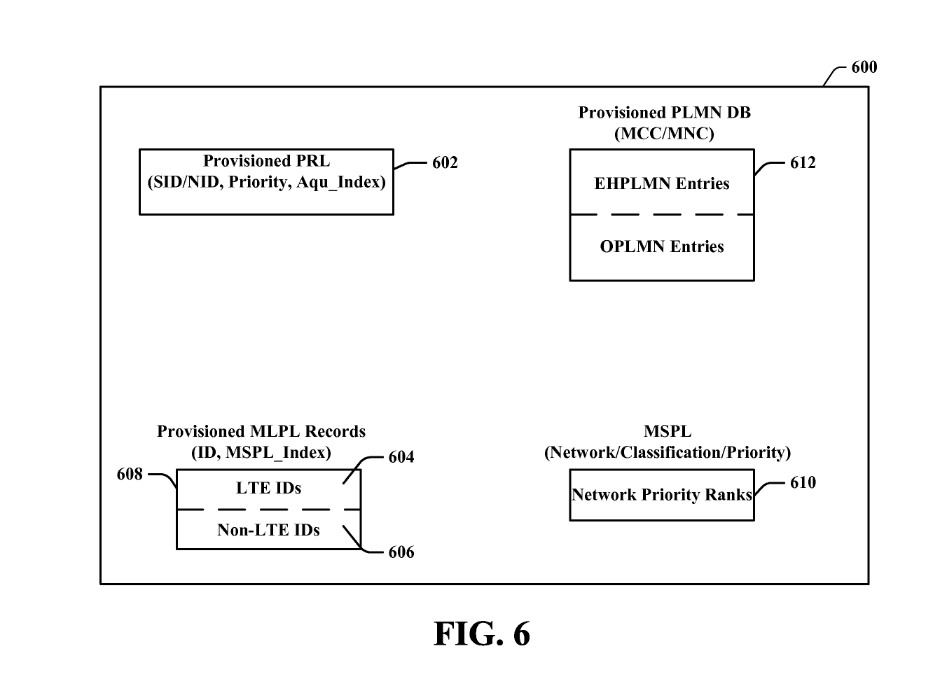

FIG. 6 is a diagram illustrating another example of set MMSS files 600. Generally MMSS files 600 may include a PRL 602, a MLPL 608 with different entries 604 and 606, a MSPL 610, and a PLMN database 612. In one aspect, the PRL may be formatted to include at least a SID/NID, a priority value, and an acquisition index value. In one aspect, MLPL may include records formatted to at least include an identifier (e.g., mobile county code (MCC, SID/NID)), and a MSPL index value. In one aspect, MSPL may include records formatted to at least include a network descriptor, a classification value (e.g., home, any, etc.), and a priority value (e.g., More, Same, etc.). In one aspect, PLMN database may include MCC and mobile network values that may be included as an EHPLMN entry, or an OPLMN entry.

MMSS provisioning scheme, as depicted in FIG. 6, uses fine grained MLPL entry definition to differentiate between GEOs with and without LTE coverage. In such an aspect, MLPL1 604 may list systems that belong to the LTE-Present Location group. In such an aspect, at least one SID/NID from each GEO that lies within a LTE coverage area is listed. Further, MLPL2 may list systems that belong to the LTE-Not Present Location group. In such an aspect, at least one SID/NID from each GEO that lies outside LTE coverage is listed. As only MLPL1 604 includes systems that belong to the LTE-present location group, when the UE is not within a GEO included in MLPL1 604 the UE avoids starting of a BSR timer when UE is camped one of the 3GPP2 systems that does not include LTE coverage.

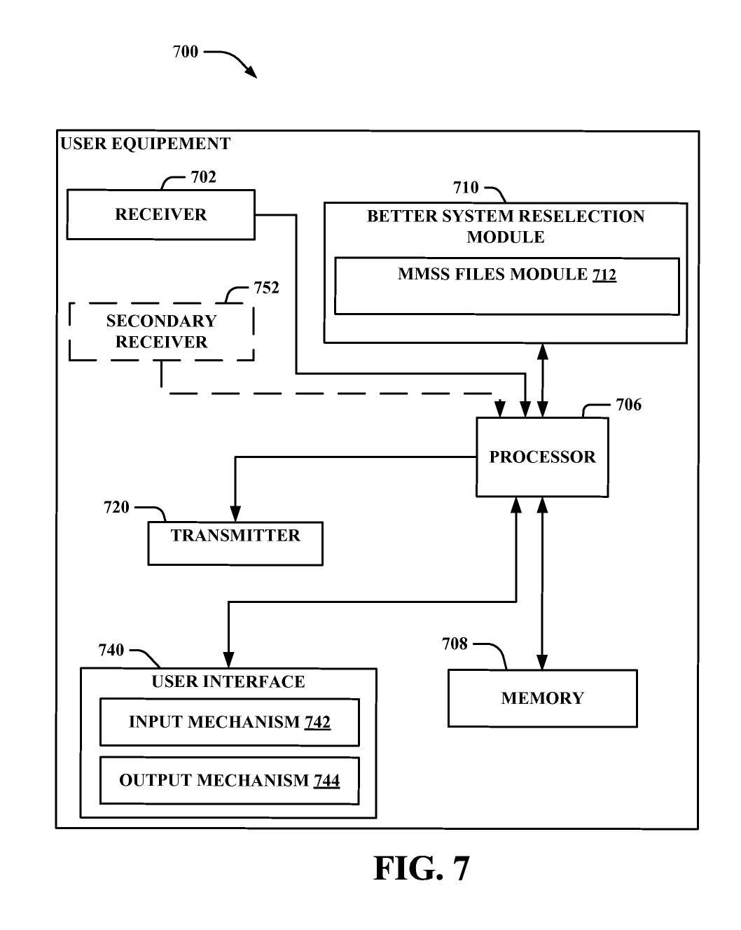

FIG. 7 illustrates of a user equipment (UE) 700 (e.g. a client device, wireless communications device (WCD), etc.) that assist in avoiding unnecessary scanning during a BSR procedure. UE 700 comprises receiver 702 that receives one or more signal from, for instance, one or more receive antennas (not shown), performs typical actions on (e.g., filters, amplifies, downconverts, etc.) the received signal, and digitizes the conditioned signal to obtain samples. Receiver 702 can further comprise an oscillator that can provide a carrier frequency for demodulation of the received signal and a demodulator that can demodulate received symbols and provide them to processor 706 for channel estimation. In one aspect, UE 700 may further comprise secondary receiver 752 and may receive additional channels of information.

Processor 706 can be a processor dedicated to analyzing information received by receiver 702 and/or generating information for transmission by one or more transmitters 720 (for ease of illustration, only one transmitter is shown), a processor that controls one or more components of UE 700, and/or a processor that both analyzes information received by receiver 702 and/or receiver 752, generates information for transmission by transmitter 720 for transmission on one or more transmitting antennas (not shown), and controls one or more components of UE 700.

In one aspect, processor 706 may provide means for detecting initiation of a BSR procedure for a multimode UE currently being served by a 3GPP2 based network, and means for determining whether to scan for a 3GPP based network based on one or more MMSS files.

UE 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods is intended to comprise, without being limited to, these and any other suitable types of memory.

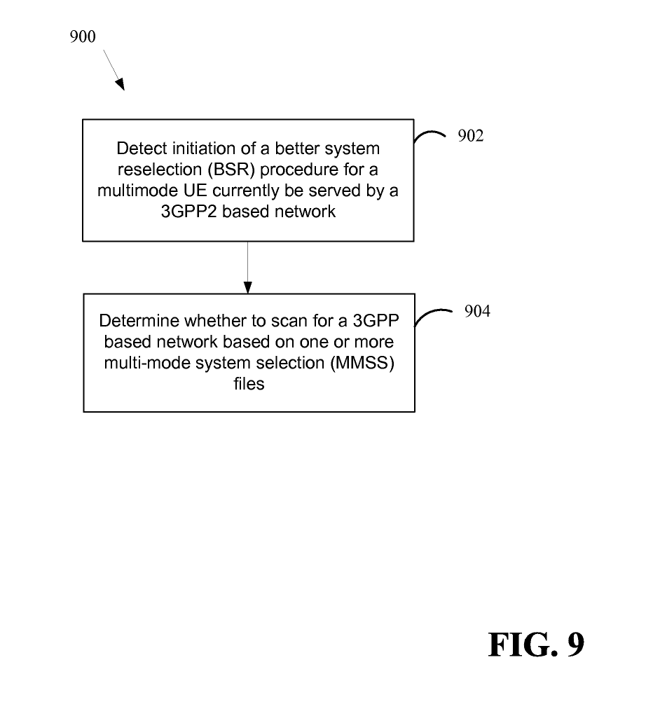

UE 700 can further include BSR module 710. BSR module 710 may include MMSS files module 712. In one aspect, MMSS files module 712 is operable to allow UE 700 to avoid performing a scanning for a 3GPP based network when the UE 700 is not within a GEO that supports 3GPP. MMSS files module 712 may include MMSS files provisioned according to one or more of FIGS. 4-6. Operation of BSR module 710 is depicted in the flowchart of FIG. 9.

Additionally, UE 700 may include user interface 740. User interface 740 may include input mechanisms 742 for generating inputs into UE 700, and output mechanism 744 for generating information for consumption by the user of UE 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, output mechanism 744 may include a display operable to present content that is in image or video format or an audio speaker to present content that is in an audio format.

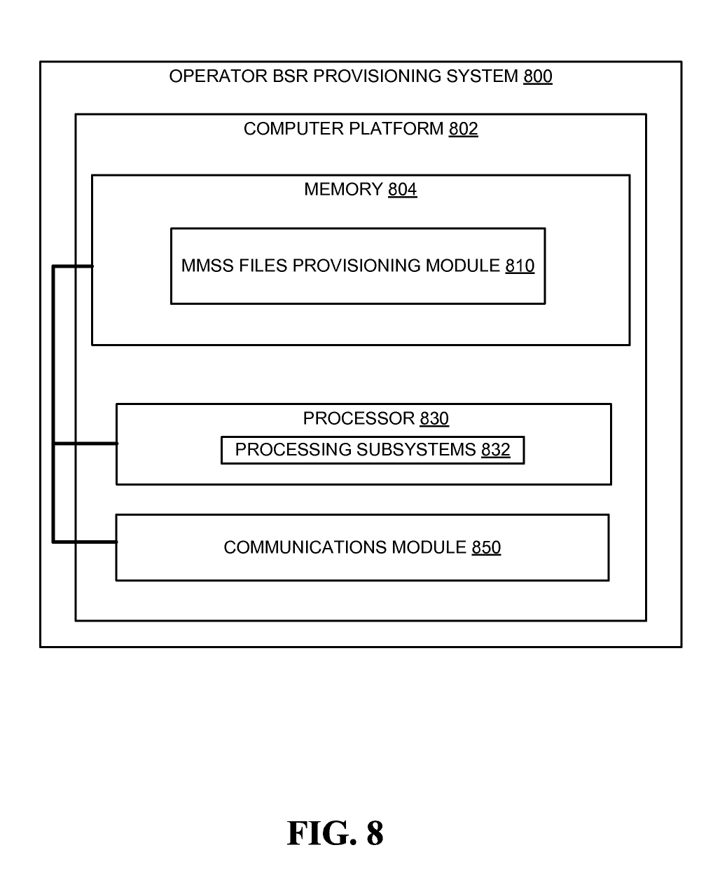

FIG. 8 illustrates a detailed block diagram of Operator BSR Provisioning system 800. SMS processing system 800 may include at least one of any type of hardware, server, personal computer, mini computer, mainframe computer, or any computing device either special purpose or general computing device. Further, the modules and applications described herein as being operated on or executed by Operator BSR Provisioning system 800 may be executed entirely on a single network device, as shown in FIG. 8, or alternatively, in other aspects, separate servers, databases or computer devices may work in concert to provide data in usable formats to parties, and/or to provide a separate layer of control in the data flow between devices, such as UE 202, eNodeB 206, mobile station 238, etc., and the modules and applications executed by Operator BSR Provisioning system 800.

Operator BSR Provisioning system 800 includes computer platform 802 that can transmit and receive data across wired and wireless networks, and that can execute routines and applications. Computer platform 802 includes memory 804, which may comprise volatile and nonvolatile memory such as read-only and/or random-access memory (ROM and RAM), EPROM, EEPROM, flash cards, or any memory common to computer platforms. Further, memory 804 may include one or more flash memory cells, or may be any secondary or tertiary storage device, such as magnetic media, optical media, tape, or soft or hard disk. Further, computer platform 802 also includes processor 830, which may be an application-specific integrated circuit (“ASIC”), or other chipset, logic circuit, or other data processing device. Processor 830 may include various processing subsystems 832 embodied in hardware, firmware, software, and combinations thereof, that enable the functionality of Operator BSR Provisioning system 800 and the operability of the network device on a wired or wireless network.

In one aspect, processor 830 may provide means for determining that a GEO includes one or more cells that provide 3GPP coverage. Processor 830 may further provide means for provisioning MMSS files to distinguish the GEO than includes one or more cells that support 3GPP coverage from one or more GEOs that do not include 3GPP coverage.

Computer platform 802 further includes communications module 850 embodied in hardware, firmware, software, and combinations thereof, that enables communications among the various components of SMS processing system 800, as well as between Operator BSR Provisioning system 800, and UE 202. Communication module 850 may include the requisite hardware, firmware, software and/or combinations thereof for establishing a wireless communication connection. According to described aspects, communication module 850 may include the necessary hardware, firmware and/or software to facilitate wireless and/or wireline communications with UE 202.

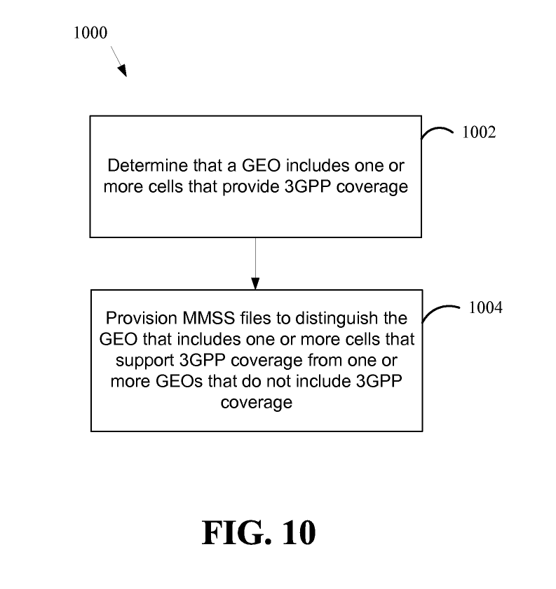

Memory 804 of Operator BSR Provisioning system 800 includes MMSS files provisioning module 810. In one aspect, MMSS files provisioning module 810 may be operable to provision MMSS filing using one or more schemes so as to avoid unnecessary BSR scans where there is no 3GPP coverage. In one aspect, MMSS files provisioning module 810 is operable to split PRLs into two categories. A first category including “LTE-Present locations” which includes GEOs that overlap with an area that has LTE service. A second category includes “LTE-NOT Present locations” which includes GEOs that do not overlap with an area that has LTE service. In operation, one or more provisioned MMSS files may be used to allow a UE to distinguish between being located in a region covered by the first category and a region covered by the second category. When the UE is in a region covered by the second category, then there is no need to perform a BSR procedure, as not LTE coverage is available. Provisioning schemes are depicted with reference to FIGS. 4-6 and their operations are described with reference to FIGS. 9 and 10.

FIGS. 9 and 10 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 9 illustrates a flowchart 900 describing a method for avoiding performance of a BSR procedure when in a region in which no LTE coverage is available.

The method detects initiation of a BSR procedure for a multimode UE currently being served by a 3GPP2 based network (902). In one aspect, the BSR procedure may be initiated periodically by the multi-mode UE. In one aspect, the 3GPP2 based network is a CDMA2000 network. In addition, the method determines whether to scan for a 3GPP based network based on one or more MMSS files (904). The MMSS files may include a preferred roaming list (PRL).

In one aspect, the provisioned MMSS files allow the multimode UE to interpret inclusion of an extended system record in the PRL to indicate that a 3GPP based network is available within a GEO.

In another aspect, the provisioned MMSS files allow the multimode UE to detect an extended system record value for a GEO in which the multi-mode UE is present and either determine that the extend system record value maps to a reserved mobile country code (MCC), the reserved MCC is used to indicate that a GEO does not include 3GPP coverage, or determine that the extended system record value maps to a standard MCC, the standard MCC is used to indicate that a GEO does include 3GPP coverage. In such an aspect, the extended record value may reference one or more MMSS location associated priority lists (MLPLs), the reserved MCC and the standard MCC may be included in different MLPL entries and reference different MMSS system priority lists (MSPLs), the MSPL referenced by the reserved MCC lists 3GPP2 networks as highest priority, and the MSPL referenced by the standard MCC lists 3GPP networks as highest priority.

In still another aspect, the provisioned MMSS files allow the multimode UE to interpret MLPL entries to determine whether the UE is within a GEO that supports LTE. In such an aspect, the MLPL may be provisioned with a first set of entries that indicate regions in which 3GPP coverage is available, and a second set of entries that indicate regions in which no 3GPP coverage is available. In one aspect, the 3GPP based network is a LTE network. Further, each of the MLPL entries in the first set and second set include a system identifier (SID) and node identifier (NID) values. In one aspect, the methods may further scan for a 3GPP based network upon a determination that the multi-mode UE is within a GEO that includes 3GPP coverage.

FIG. 10 illustrates a flowchart 1000 describing a method for provisions MMSS files to avoid performance of a BSR procedure by a UE when the UE is in a region in which no LTE coverage is available.

The method determines that a GEO includes one or more cells that may provide 3GPP coverage (1002). In one aspect, a 3GPP based network is a LTE network. In one aspect, the operator may convert a network map of 3GPP2 and LTE coverage into areas with and without LTE coverage. In addition, the method provisions MMSS files to distinguish the GEO than includes one or more cells that support 3GPP coverage from one or more GEOs that do not include 3GPP coverage (1004).

The MMSS files may be provisioned to allow the multimode UE to interpret inclusion of an extended system record in the PRL to indicate that a 3GPP based network is available within a GEO. In other words, the GEOs in areas with LTE coverage may be provisioned with an extended system record and the GEOs in areas without LTE coverage may be provisioned without extended system record.

In another aspect, the MMSS files may be provisioned to allow the multimode UE to detect an extended system record value for a GEO in which the multi-mode UE is present and either determine that the extend system record value maps to a reserved mobile country code (MCC), the reserved MCC is used to indicate that a GEO does not include 3GPP coverage, or determine that the extended system record value maps to a standard MCC, the standard MCC is used to indicate that a GEO does include 3GPP coverage. In such an aspect, the extended record value may reference one or more MMSS location associated priority lists (MLPLs), the reserved MCC and the standard MCC may be included in different MLPL entries and reference different MMSS system priority lists (MSPLs), the MSPL referenced by the reserved MCC lists 3GPP2 networks as highest priority, and the MSPL referenced by the standard MCC lists 3GPP networks as highest priority. In other words, the systems in areas with LTE coverage may be grouped together in one MLPL record and systems in areas without LTE coverage may be grouped together in another MLPL record.

Further in another aspect, the MMSS files may be provisioned to allow the multimode UE to interpret MLPL entries to determine whether the UE is within a GEO that supports LTE. In such an aspect, the MLPL may be provisioned with a first set of entries that indicate regions in which 3GPP coverage is available, and a second set of entries that indicate regions in which no 3GPP coverage is available.

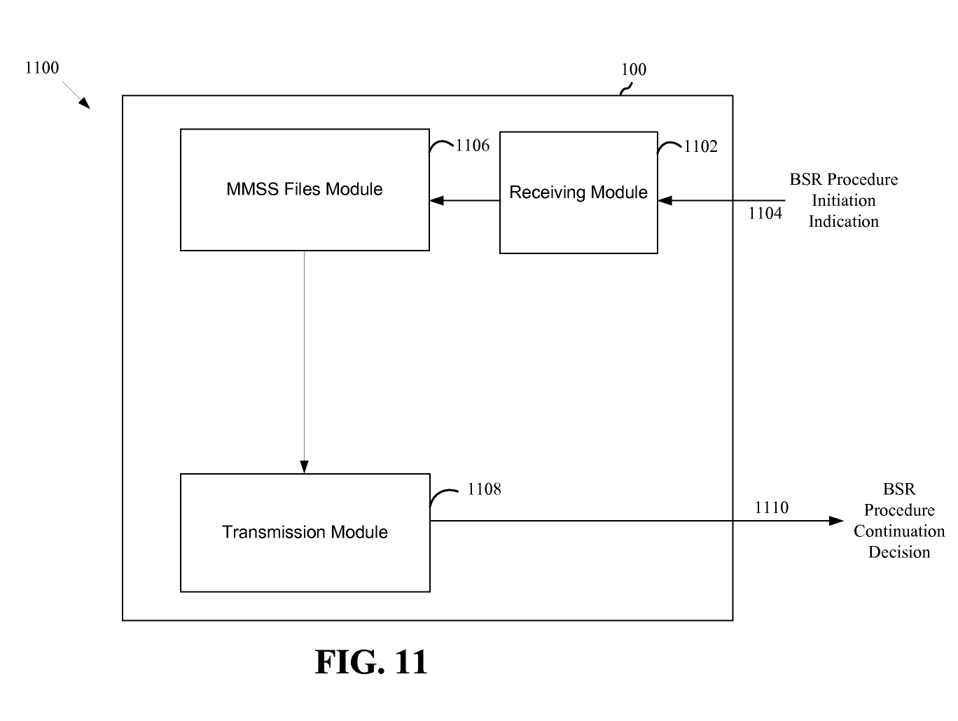

FIG. 11 is a conceptual block diagram 1100 illustrating the functionality of an exemplary apparatus 100. The apparatus 100 includes a module 1102 that receives an indication that the UE has initiated a BSR procedure 1104, a module 1106 that assists apparatus 100 in determining whether to perform a scan for a better system as part of the BSR procedure, a module 1108 that transmits the BSR procedure continuation decision 1110. The apparatus 100 may include additional modules that perform each of the steps in the aforementioned flow charts. As such, each step in the aforementioned flow charts may be performed by a module and the apparatus 100 may include one or more of those modules.

In one configuration, the apparatus 100 for wireless communication includes means for detecting initiation of a BSR procedure for a multimode UE currently being served by a 3GPP2 based network. The apparatus 100 for wireless communication further includes means for determining whether to scan for a 3GPP based network based on one or more MMSS files. The apparatus 100 for wireless communication further includes means for interpreting inclusion of an extended system record in a PRL to indicate that a 3GPP based network is available within a GEO. The apparatus 100 for wireless communication further includes means for detecting an extended system record value for a GEO in which the multi-mode UE is present, and means for determining that the extend system record value maps to a reserved MCC, where the reserved MCC is used to indicate that a GEO does not include 3GPP coverage, or means for determining that the extended system record value maps to a standard MCC, where the standard MCC is used to indicate that a GEO does include 3GPP coverage. In one an aspect, the MLPL may be provisioned with a first set of entries that indicate regions in which 3GPP coverage is available, and a second set of entries that indicate regions in which no 3GPP coverage is available. In such an aspect, the apparatus 100 for wireless communication further includes means for determining to scan for the 3GPP based when the multi-mode UE is within a region included in the first set of entries.

The aforementioned means may be one or more of the aforementioned modules of the apparatus 100 (see FIG. 7) and/or the processing system 114 configured to perform the functions recited by the aforementioned means. As described supra, the processing system 114 includes processor 706. As such, in one configuration, the aforementioned means may be the processor 706 configured to perform the functions recited by the aforementioned means.

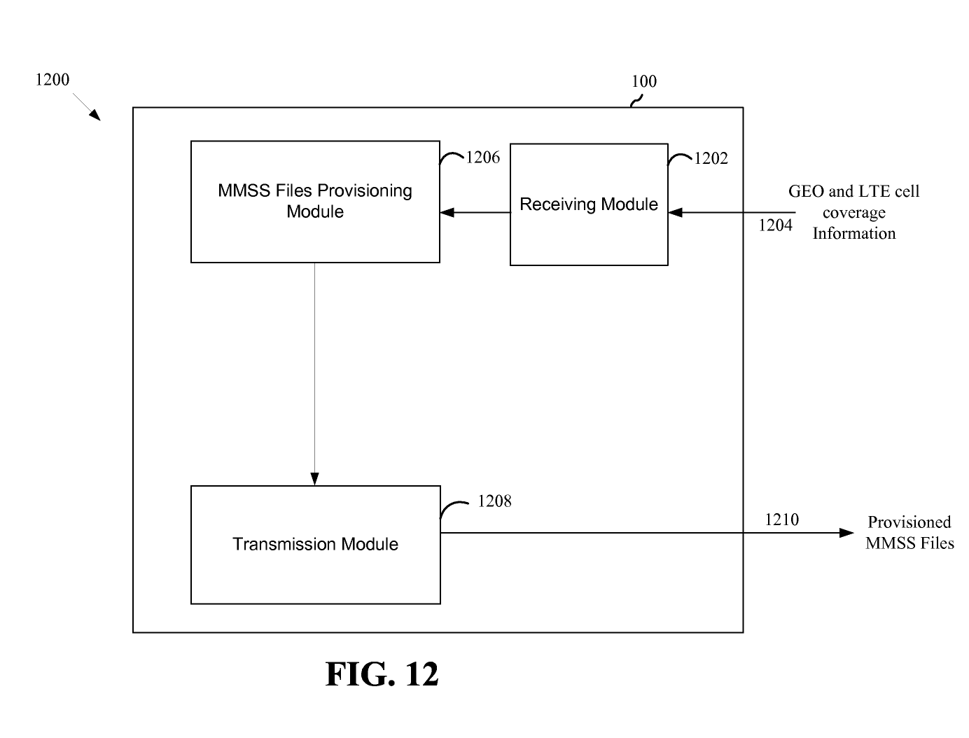

FIG. 12 is a conceptual block diagram 1200 illustrating the functionality of an exemplary apparatus 100. The apparatus 100 includes a module 1202 that receives an indication whether a GEO includes 3GPP based coverage along with 3GPP2 coverage 1104, a module 1106 that assists apparatus 100 in provisioning MMS files, a module 1408 that transmits the provisioned MMSS files 1210. The apparatus 100 may include additional modules that perform each of the steps in the aforementioned flow charts. As such, each step in the aforementioned flow charts may be performed by a module and the apparatus 100 may include one or more of those modules.

In one configuration, the apparatus 100 for wireless communication includes means for determining that a GEO includes one or more cells that provide 3GPP coverage. The apparatus 100 for wireless communication further includes means provisioning MMSS files to distinguish the GEO than includes one or more cells that support 3GPP coverage from one or more GEOs that do not include 3GPP coverage. The apparatus 100 for wireless communication further includes means for including an extended system record in a PRL to indicate that a 3GPP based network is available within a GEO. The apparatus 100 for wireless communication further includes means for including an extended system record value for a GEO in which the multi-mode UE is present, and means for provisioning that the extend system record value maps to a reserved MCC, where the reserved MCC is used to indicate that a GEO does not include 3GPP coverage, or means for provisioning that the extended system record value maps to a standard MCC, where the standard MCC is used to indicate that a GEO does include 3GPP coverage. In one aspect, the apparatus 100 for wireless communication further includes means for provisioning the MLPL with a first set of entries that indicate regions in which 3GPP coverage is available, and a second set of entries that indicate regions in which no 3GPP coverage is available.

The aforementioned means may be one or more of the aforementioned modules of the apparatus 100 (see FIG. 8) and/or the processing system 114 configured to perform the functions recited by the aforementioned means. As described supra, the processing system 114 includes processor 830. As such, in one configuration, the aforementioned means may be the processor 830 configured to perform the functions recited by the aforementioned means.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The word “exemplary” is used herein to mean serving as an example, instance, or illustration. Any aspect or design described herein as “exemplary” is not necessarily to be construed as preferred or advantageous over other aspects or designs. Additionally, as used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

What is claimed is:

1. A method of wireless communications, comprising:
detecting initiation of a better system reselection (BSR) procedure for a multimode user equipment (UE) currently being served by a 3GPP2 based network; and
determining whether to scan for a 3GPP based network based on one or more multi-mode system selection (MMSS) files.

2. The method of claim 1, wherein the MMSS files include a preferred roaming list (PRL), and wherein the determining whether to scan further comprises:
interpreting inclusion of an extended system record in the PRL to indicate that a 3GPP based network is available within a geographic region (GEO).

3. The method of claim 1, wherein the MMSS files include a PRL, and wherein the determining whether to scan further:
detecting an extended system record value for a GEO in which the multi-mode UE is present; and
determining that the extend system record value maps to a reserved mobile country code (MCC), wherein the reserved MCC is used to indicate that a GEO does not include 3GPP coverage; or
determining that the extended system record value maps to a standard MCC, wherein the standard MCC is used to indicate that a GEO does include 3GPP coverage.

4. The method of claim 3, wherein the extended record value references one or more MMSS location associated priority lists (MLPLs), wherein the reserved MCC and the standard MCC are included in different MLPL entries and reference different MMSS system priority lists (MSPLs), wherein the MSPL referenced by the reserved MCC lists 3GPP2 networks as highest priority, and wherein the MSPL referenced by the standard MCC lists 3GPP networks as highest priority.

5. The method of claim 1, wherein the MMSS files include a PRL, wherein the PRL includes one or more entries that reference a MLPL, wherein the MLPL is provisioned with a first set of entries that indicate regions in which 3GPP coverage is available, and a second set of entries that indicate regions in which no 3GPP coverage is available, and wherein the determining whether to scan further comprises:
determining to scan for the 3GPP based when the multi-mode UE is within a region included in the first set of entries.

6. The method of claim 5, wherein each of the MLPL entries in the first set and second set include a system identifier (SID) and node identifier (NID) values.

7. The method of claim 1, wherein the BSR procedure is initiated periodically by the multi-mode UE.

8. The method of claim 1, further comprising scanning for a 3GPP based network upon a determination that the multi-mode UE is within a GEO that includes 3GPP coverage.

9. The method of claim 1, wherein the 3GPP2 based network is a CDMA2000 network, and wherein the 3GPP based network is a Long Term Evolution (LTE) network.

10. The method of claim 1, further comprising receiving an updated set of MMSS files from an operator, wherein the updated set of MMSS files includes updates to the one or more MMSS files.

11. A method of wireless communications, comprising:
determining that a GEO includes one or more cells that provide 3GPP coverage; and
provisioning MMSS files to distinguish the GEO than includes one or more cells that support 3GPP coverage from one or more GEOs that do not include 3GPP coverage.

12. The method of claim 11, wherein the provisioning further comprises including an extended system record in a PRL to indicate that a 3GPP based network is available within a GEO.

13. The method of claim 11, wherein the provisioning further comprises:
including an extended system record value for a GEO in which the multi-mode UE is present; and
provisioning that the extend system record value maps to a reserved MCC, wherein the reserved MCC is used to indicate that a GEO does not include 3GPP coverage; or
provisioning that the extended system record value maps to a standard MCC, wherein the standard MCC is used to indicate that a GEO does include 3GPP coverage.

14. The method of claim 11, wherein the provisioning further comprises provisioning a MLPL with a first set of entries that indicate regions in which 3GPP coverage is available, and a second set of entries that indicate regions in which no 3GPP coverage is available.

15. The method of claim 11, wherein the determining further comprises converting a network map depicting 3GPP2 and 3GPP coverage regions into a map depicting one or more GEOs with 3GPP coverage and one or more GEOs without 3GPP coverage.

16. The method of claim 15, wherein the determining further comprises provisioning the one or more GEOs with 3GPP coverage with an extended system record.

17. The method of claim 15, wherein the determining further comprises:
grouping the one or more GEOs with 3GPP coverage in a first MLPL record; and
grouping the one or more GEOs without 3GPP coverage in a second MLPL record.

18. An apparatus for wireless communication, comprising:
means for detecting initiation of a BSR procedure for a multimode UE currently being served by a 3GPP2 based network; and
means for determining whether to scan for a 3GPP based network based on one or more MMSS files.

19. The apparatus of claim 18, wherein the MMSS files include a PRL, and wherein the means for determining whether to scan further comprises means for interpreting inclusion of an extended system record in the PRL to indicate that a 3GPP based network is available within a GEO.

20. The apparatus of claim 18, wherein the MMSS files include a PRL, and wherein the means for determining whether to scan further comprises:
means for detecting an extended system record value for a GEO in which the multi-mode UE is present; and
means for determining that the extend system record value maps to a reserved MCC, wherein the reserved MCC is used to indicate that a GEO does not include 3GPP coverage; or
means for determining that the extended system record value maps to a standard MCC, wherein the standard MCC is used to indicate that a GEO does include 3GPP coverage.

21. The apparatus of claim 20, wherein the extended record value references one or more MLPLs, wherein the reserved MCC and the standard MCC are included in different MLPL entries and reference different MSPLs, wherein the MSPL referenced by the reserved MCC lists 3GPP2 networks as highest priority, and wherein the MSPL referenced by the standard MCC lists 3GPP networks as highest priority.

22. The apparatus of claim 18, wherein the MMSS files include a PRL, wherein the PRL includes one or more entries that reference a MLPL, wherein the MLPL is provisioned with a first set of entries that indicate regions in which 3GPP coverage is available, and a second set of entries that indicate regions in which no 3GPP coverage is available, and wherein the means for determining whether to scan further comprises:
means for determining to scan for the 3GPP based when the multi-mode UE is within a region included in the first set of entries.

23. The apparatus of claim 22, wherein each of the MLPL entries in the first set and second set include a system identifier SID/NID values.

24. The apparatus of claim 18, wherein the BSR procedure is initiated periodically by the multi-mode UE.

25. The apparatus of claim 18, further comprising means for scanning for a 3GPP based network upon a determination that the multi-mode UE is within a GEO that includes 3GPP coverage.

26. The apparatus of claim 18, wherein the 3GPP2 based network is a CDMA2000 network, and wherein the 3GPP based network is a LTE network.

27. The apparatus of claim 18, further comprising means for receiving an updated set of MMSS files from an operator, wherein the updated set of MMSS files includes updates to the one or more MMSS files.

28. An apparatus for wireless communications, comprising:
means for determining that a GEO includes one or more cells that provide 3GPP coverage; and
means for provisioning MMSS files to distinguish the GEO than includes one or more cells that support 3GPP coverage from one or more GEOs that do not include 3GPP coverage.

29. The apparatus of claim 28, wherein the means for provisioning further comprises means for including an extended system record in a PRL to indicate that a 3GPP based network is available within a GEO.

30. The apparatus of claim 28, wherein the means for provisioning further comprises:
means for including an extended system record value for a GEO in which the multi-mode UE is present; and
means for provisioning that the extend system record value maps to a reserved MCC, wherein the reserved MCC is used to indicate that a GEO does not include 3GPP coverage; or
means for provisioning that the extended system record value maps to a standard MCC, wherein the standard MCC is used to indicate that a GEO does include 3GPP coverage.

31. The apparatus of claim 28, wherein the means for provisioning further comprises means for provisioning a MLPL with a first set of entries that indicate regions in which 3GPP coverage is available, and a second set of entries that indicate regions in which no 3GPP coverage is available.

32. The apparatus of claim 28, wherein the means for determining further comprises means for converting a network map depicting 3GPP2 and 3GPP coverage regions into a map depicting one or more GEOs with 3GPP coverage and one or more GEOs without 3GPP coverage.

33. The apparatus of claim 32, wherein the means for determining further comprises means for provisioning the one or more GEOs with 3GPP coverage with an extended system record.

34. The apparatus of claim 32, wherein the means for determining further comprises:
means for grouping the one or more GEOs with 3GPP coverage in a first MLPL record; and
means for grouping the one or more GEOs without 3GPP coverage in a second MLPL record.

35. A computer program product, comprising:
a computer-readable medium comprising code for:
detecting initiation of a BSR procedure for a multimode UE currently being served by a 3GPP2 based network; and
determining whether to scan for a 3GPP based network based on one or more MMSS files.

36. The computer program product of claim 35, wherein the MMSS files include a PRL, and wherein the code for determining whether to scan further comprises code for interpreting inclusion of an extended system record in the PRL to indicate that a 3GPP based network is available within a GEO.

37. The computer program product of claim 35, wherein the MMSS files include a PRL, and wherein the code for determining whether to scan further comprises code for:
detecting an extended system record value for a GEO in which the multi-mode UE is present; and
determining that the extend system record value maps to a reserved MCC, wherein the reserved MCC is used to indicate that a GEO does not include 3GPP coverage; or
determining that the extended system record value maps to a standard MCC, wherein the standard MCC is used to indicate that a GEO does include 3GPP coverage.

38. The computer program product of claim 37, wherein the extended record value references one or more MLPLs, wherein the reserved MCC and the standard MCC are included in different MLPL entries and reference different MSPLs, wherein the MSPL referenced by the reserved MCC lists 3GPP2 networks as highest priority, and wherein the MSPL referenced by the standard MCC lists 3GPP networks as highest priority.

39. The computer program product of claim 35, wherein the MMSS files include a PRL, wherein the PRL includes one or more entries that reference a MLPL, wherein the MLPL is provisioned with a first set of entries that indicate regions in which 3GPP coverage is available, and a second set of entries that indicate regions in which no 3GPP coverage is available, and wherein the code for determining whether to scan further comprises code for:
determining to scan for the 3GPP based when the multi-mode UE is within a region included in the first set of entries.

40. The computer program product of claim 39, wherein each of the MLPL entries in the first set and second set include a SID/NID values.

41. The computer program product of claim 35, wherein the BSR procedure is initiated periodically by the multi-mode UE.

42. The computer program product of claim 35, wherein the computer readable medium further comprises code for scanning for a 3GPP based network upon a determination that the multi-mode UE is within a GEO that includes 3GPP coverage.

43. The computer program product of claim 35, wherein the 3GPP2 based network is a CDMA2000 network, and wherein the 3GPP based network is a LTE network.

44. The computer program product of claim 35, wherein the computer readable medium further comprises code for receiving an updated set of MMSS files from an operator, wherein the updated set of MMSS files includes updates to the one or more MMSS files.

45. A computer program product, comprising:
a computer readable medium comprising code for:
determining that a GEO includes one or more cells that provide 3GPP coverage; and
provisioning MMSS files to distinguish the GEO than includes one or more cells that support 3GPP coverage from one or more GEOs that do not include 3GPP coverage.

46. The computer program product of claim 45, wherein the code for provisioning further comprises code for including an extended system record in a PRL to indicate that a 3GPP based network is available within a GEO.

47. The computer program product of claim 45, wherein the code for provisioning further comprises code for:
including an extended system record value for a GEO in which the multi-mode UE is present; and
provisioning that the extend system record value maps to a reserved MCC, wherein the reserved MCC is used to indicate that a GEO does not include 3GPP coverage; or
provisioning that the extended system record value maps to a standard MCC, wherein the standard MCC is used to indicate that a GEO does include 3GPP coverage.

48. The computer program product of claim 45, wherein the code for provisioning further comprises code for provisioning a MLPL with a first set of entries that indicate regions in which 3GPP coverage is available, and a second set of entries that indicate regions in which no 3GPP coverage is available.

49. The computer program product of claim 45, wherein the computer readable medium further comprises code for converting a network map depicting 3GPP2 and 3GPP coverage regions into a map depicting one or more GEOs with 3GPP coverage and one or more GEOs without 3GPP coverage.

50. The computer program product of claim 49, wherein the computer readable medium further comprises code for provisioning the one or more GEOs with 3GPP coverage with an extended system record.

51. The computer program product of claim 49, wherein the computer readable medium further comprises code for:
grouping the one or more GEOs with 3GPP coverage in a first MLPL record; and
grouping the one or more GEOs without 3GPP coverage in a second MLPL record.

52. An apparatus for wireless communication, comprising:
a processing system configured to:
detect initiation of a BSR procedure for a multimode UE currently being served by a 3GPP2 based network; and
determine whether to scan for a 3GPP based network based on one or more MMSS files.

53. The apparatus of claim 52, wherein the MMSS files include a PRL, and wherein the processing system is further operable to interpret inclusion of an extended system record in the PRL to indicate that a 3GPP based network is available within a GEO.

54. The apparatus of claim 52, wherein the MMSS files include a PRL, and wherein the processing system is further operable to:
detect an extended system record value for a GEO in which the multi-mode UE is present; and
determine that the extend system record value maps to a reserved MCC, wherein the reserved MCC is used to indicate that a GEO does not include 3GPP coverage; or
determine that the extended system record value maps to a standard MCC, wherein the standard MCC is used to indicate that a GEO does include 3GPP coverage.

55. The apparatus of claim 54, wherein the extended record value references one or more MLPLs, wherein the reserved MCC and the standard MCC are included in different MLPL entries and reference different MSPLs, wherein the MSPL referenced by the reserved MCC lists 3GPP2 networks as highest priority, and wherein the MSPL referenced by the standard MCC lists 3GPP networks as highest priority.

56. The apparatus of claim 52, wherein the MMSS files include a PRL, wherein the PRL includes one or more entries that reference a MLPL, wherein the MLPL is provisioned with a first set of entries that indicate regions in which 3GPP coverage is available, and a second set of entries that indicate regions in which no 3GPP coverage is available, and wherein the processing system is further operable to:
determine to scan for the 3GPP based when the multi-mode UE is within a region included in the first set of entries.

57. The apparatus of claim 56, wherein each of the MLPL entries in the first set and second set include a system identifier SID/NID values.

58. The apparatus of claim 52, wherein the BSR procedure is initiated periodically by the multi-mode UE.

59. The apparatus of claim 52, wherein the processing system is further operable to scan for a 3GPP based network upon a determination that the multi-mode UE is within a GEO that includes 3GPP coverage.

60. The apparatus of claim 52, wherein the 3GPP2 based network is a CDMA2000 network, and wherein the 3GPP based network is a LTE network.

61. The apparatus of claim 52, wherein the processing system is further operable to receive an updated set of MMSS files from an operator, wherein the updated set of MMSS files includes updates to the one or more MMSS files.

62. An apparatus for wireless communication, comprising:
a processing system configured to:
determine that a GEO includes one or more cells that provide 3GPP coverage; and
provision MMSS files to distinguish the GEO than includes one or more cells that support 3GPP coverage from one or more GEOs that do not include 3GPP coverage.

63. The apparatus of claim 62, wherein the processing system is further configured to include an extended system record in a PRL to indicate that a 3GPP based network is available within a GEO.

64. The apparatus of claim 62, wherein the processing system is further configured to:
include an extended system record value for a GEO in which the multi-mode UE is present; and
provision that the extend system record value maps to a reserved MCC, wherein the reserved MCC is used to indicate that a GEO does not include 3GPP coverage; or
provision that the extended system record value maps to a standard MCC, wherein the standard MCC is used to indicate that a GEO does include 3GPP coverage.

65. The apparatus of claim 62, wherein the processing system is further configured to provision a MLPL with a first set of entries that indicate regions in which 3GPP coverage is available, and a second set of entries that indicate regions in which no 3GPP coverage is available.

66. The apparatus of claim 62, wherein the processing system is further configured to convert a network map depicting 3GPP2 and 3GPP coverage regions into a map depicting one or more GEOs with 3GPP coverage and one or more GEOs without 3GPP coverage.

67. The apparatus of claim 66, wherein the processing system is further configured to provision the one or more GEOs with 3GPP coverage with an extended system record.

68. The apparatus of claim 66, wherein the processing system is further configured to:
group the one or more GEOs with 3GPP coverage in a first MLPL record; and
group the one or more GEOs without 3GPP coverage in a second MLPL record.
